(19) United States
(12) Patent Application Publication
(10) Pub. No.: US 2026/0279197 A1
(43) Pub. Date: Sep. 17, 2026

(54) METHOD OF CONTROLLING TRAFFIC FLOW AND DETECTING TRAFFIC RULE VIOLATIONS AND SYSTEM PERFORMING THE SAME

(71) Applicants: Wuyang Qian, Nantong (CN); Keven Feng, San Jose, CA (US)

(72) Inventors: Wuyang Qian, Nantong (CN); Keven Feng, San Jose, CA (US)

(21) Appl. No.: 19/667,642

(22) Filed: May 4, 2026

Related U.S. Application Data
(63) Continuation-in-part of application No. 18/942,701, filed on Nov. 10, 2024.
Application No. 18/942,701 is a continuation-in-part of application No. 17/752,624, filed on May 24, 2022, now Pat. No. 12,175,864.

(51) Int. Cl. G08G 1/08; G06Q 50/26; G06T 5/70; G06T 7/20; G06V 20/54; G08G 1/01; G08G 1/017; G08G 1/04; G08G 1/052; G08G 1/056; G08G 1/087

(52) U.S. Cl. CPC G08G 1/08; G06Q 50/26; G06T 5/70; G06T 7/20; G06V 20/54; G08G 1/0133; G08G 1/0175; G08G 1/04; G08G 1/052; G08G 1/056; G08G 1/087; G06T 2207/30236; G06T 2207/30242; G06V 2201/08

(57) ABSTRACT

A method controls traffic at an intersection having three or more branches. The method comprising the steps of: capturing image data by a plurality of camera units positioned at the intersection; sending the image data to a control unit; determining from the image data a plurality of variables; and based on the plurality of variables, determining speed limits, and setting orders and durations of lights of a plurality of traffic lights positioned at the intersection. A system performs the method. Advantages of instant disclosure include adjustment of on-duration of a light using weather condition; reporting vehicles violating traffic rules to police centers; blurring license plates of surrounding vehicles; and smoother traffic flows.

### CROSS-REFERENCE TO RELATED APPLICATIONS

This patent application is a Continuation-in-part application of U.S. patent application Ser. No. 18/942,701. U.S. patent application Ser. No. 18/942,701 is a Continuation-in-part application of U.S. patent application Ser. No. 17/752,624, issued as U.S. Pat. No. 12,175,864 on Dec. 24, 2024.The Disclosure made in US Patent Application Publication No. 2025/0069502 to Qian, and the Disclosure made in US Patent Application Publication No. 2023/0386329 to Qian, are hereby incorporated by reference.

### FIELD OF THE INVENTION

This invention relates generally to a method for controlling traffic flow and detecting traffic rule violations. More particularly, the present invention relates to a method for controlling traffic flow and detecting traffic rule violations and a system performing the method.

### BACKGROUND OF THE INVENTION

U.S. Pat. No. 10,490,066 to Green et al. discloses the use of sensor systems such as light detection and ranging (LiDAR) systems and color cameras such as red green blue (RGB) cameras to determine traffic data, such as the number of vehicles at a crossing, the number of vehicles turning, and the paths taken by the vehicles. US Patent Application Publication No. 2021/0334550 to Cho et al. discloses an artificial intelligent (AI) algorithm implemented by hardware circuit or software. The AI algorithms classify and label at least one vehicle in the image. US Patent Application Publication No. 2020/0293796 to Mohammadabadi et al. discloses machine learning algorithms being trained to compute information corresponding to an intersection such as intersection bounding boxes, coverage maps, attributes, and distances. US Patent Application Publication No. 2018/0096595 to et al. discloses detection of the presence of emergency vehicles based upon the captured audio data by performing a classification process.

Advantages of instant disclosure include adjustment of on-duration of a light using weather condition; reporting vehicles violating traffic rules to police centers; blurring license plates of surrounding vehicles; and smoother traffic flows.

### SUMMARY OF THE INVENTION

This invention discloses a method for controlling traffic at an intersection comprising three or more branches. The method comprising the steps of: capturing image data by a plurality of camera units positioned at the intersection; sending the image data to a control unit; determining from the image data a plurality of variables; and based on the plurality of variables, determining speed limits, and setting orders and durations of lights of a plurality of traffic lights positioned at the intersection.

### BRIEF DESCRIPTION OF THE DRAWINGS

FIG. 1 is a flowchart of a method for controlling traffic at an intersection in examples of the present disclosure.

FIG. 2 shows an intersection with three branches in examples of the present disclosure.

FIG. 3 shows an intersection with four branches in examples of the present disclosure.

FIG. 4 is a flowchart of a method for controlling traffic at an intersection in examples of the present disclosure.

FIG. 5 shows two intersections in examples of the present disclosure.

FIG. 6 is a flowchart of a method for controlling traffic at an intersection in examples of the present disclosure.

### DETAILED DESCRIPTION OF THE INVENTION

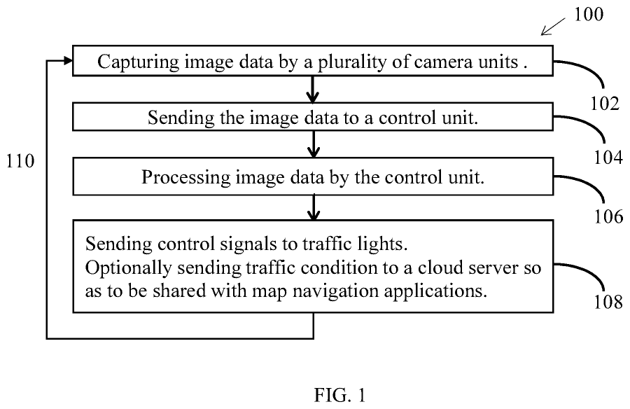

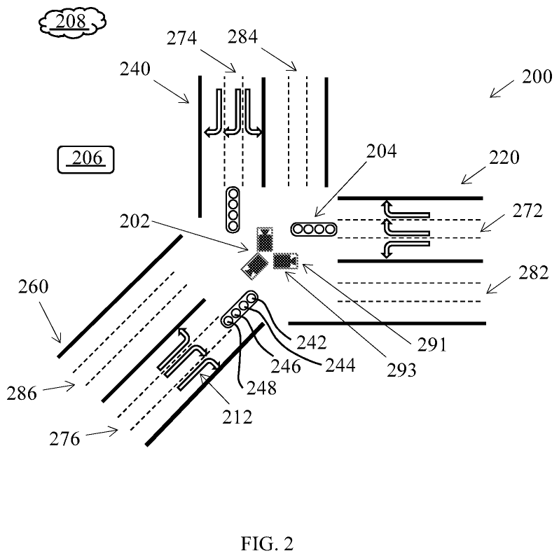

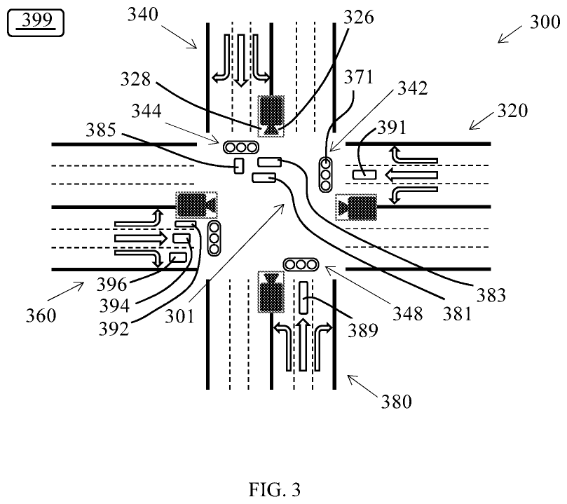

FIG. 1 is a flowchart of a method 100 for controlling traffic at an intersection in examples of the present disclosure. The intersection comprises three or more branches. For one example, an intersection 200 of FIG. 2 comprises three branches including a first branch 220, a second branch 240, and a third branch 260. The intersection 200 further comprises a plurality of road signs 212. For another example, an intersection 300 of FIG. 3 comprises four branches including a first branch 320, a second branch 340, a third branch 360, and a fourth branch 380. The method 100 may begin in block 102.

In block 102, image data of each incoming direction (for example, each of incoming direction 272, incoming direction 274, and incoming direction 276 of FIG. 2) of the three or more branches are captured by a plurality of camera units (for example, a plurality of camera units 202 of FIG. 2) positioned at the intersection. In one example, the commands to capture image data are sent from a control unit 206 to the plurality of camera units 202 and the image data comprises streaming image data. In examples of the present disclosure, each of the plurality of camera units 202 comprises a red-green-blue (RGB) photographic camera 291 and a light detection and ranging (LiDAR) depth camera 293.

In examples of the present disclosure, license plate numbers of vehicles appeared in the videos or images may be removed by an AI algorithm. The videos or images may be used for traffic violation citations or as evidences for court proceedings. Block 102 may be followed by block 104.

In block 104, the captured image data of each incoming direction are sent to the control unit 206. Block 104 may be followed by block 106.

In block 106, the image data are processed by the control unit 206. Block 106 may be followed by block 108.

In block 108, switching-on timing, on-duration, switching-off timing, and off-duration of each light of a plurality of traffic lights 204 are predetermined. The switching-on timing, on-duration, switching-off timing, and off-duration of each light of the plurality of traffic lights 204 are then adjusted based at least on control signals sent from the control unit 206 to the plurality of traffic lights 204. For one example, each of the plurality of traffic lights comprises a red light, a yellow light, and a green light. For another example, each of the plurality of traffic lights 204 comprises a red light 242, a yellow light 244, a green light 246, and a left-turn light 248.

In examples of the present disclosure, traffic condition is sent to a cloud server 208 of FIG. 2 so as to be shared with map navigation applications (APPs). Block 108 may be followed by block 102 so as to form a loop 110.

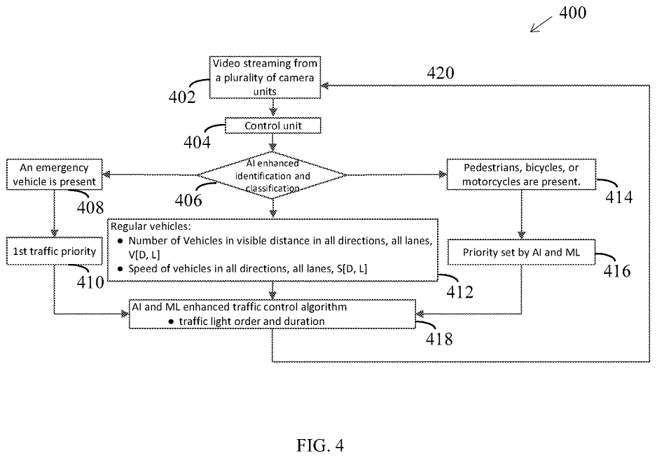

FIG. 4 is a flowchart of a method 400 for controlling traffic at an intersection in examples of the present disclosure. The intersection comprises three or more branches. For one example, an intersection 200 of FIG. 2 comprises three branches including a first branch 220, a second branch 240, and a third branch 260. For another example, an intersection 300 of FIG. 3 comprises four branches including a first branch 320, a second branch 340, a third branch 360, and a fourth branch 380. The method 400 may begin in block 402.

In block 402, image data of each incoming direction (for example, each of incoming direction 272, incoming direction 274, and incoming direction 276 of FIG. 2) of the three or more branches are captured by a plurality of camera units (for example, a plurality of camera units 202 of FIG. 2) positioned at the intersection. In one example, the commands to capture image data are sent from a control unit 206 to the plurality of camera units 202 and the image data comprises streaming image data. In examples of the present disclosure, each of the plurality of camera units 202 comprises an RGB photographic camera 291 and a LiDAR depth camera 293.

In examples of the present disclosure, image data of each outgoing direction (for example, each of outgoing direction 282, outgoing direction 284, and outgoing direction 286 of FIG. 2) of the three or more branches are captured by the plurality of camera units (for example, a plurality of camera units 202 of FIG. 2) positioned at the intersection. Block 402 may be followed by block 404.

In block 404, the captured image data of each incoming direction are sent to the control unit 206. In examples of the present disclosure, the captured image data of each incoming direction and each outgoing direction are sent to the control unit 206. Block 404 may be followed by block 406.

In block 406, the image data are processed by the control unit 206. Artificial intelligent (AI) enhanced identification and classification are determined. Block 406 may be followed by block 408, block 412, or block 414.

In block 408, from the image data of each incoming direction, it is determined that an emergency vehicle 391 of FIG. 3 is present. In one example, the emergency vehicle is an ambulance. In another example, the emergency vehicle is a fire engine. In still another example, the emergency vehicle is a police car. In examples of the present disclosure, one or more emergency flashlights or one or more sirens in the images or in the streaming videos are further used to classify if the emergency vehicle is as an ambulance, a fire engine, or a police car. Block 408 may be followed by block 410.

In block 410, the emergency vehicle 391 of FIG. 3 has the first (highest) priority. Because the emergency vehicle 391 is present, on-duration of a green light 371 of FIG. 3 of a traffic light 342 of FIG. 3 facing the emergency vehicle 391 is increased until the emergency vehicle 391 at least enters a center portion 301 of FIG. 3 of the intersection 300 of FIG. 3. If when the emergency vehicle 391 is detected, the green light 371 is off, then a traffic light 344 will phase change from green light to red light, and a traffic light 348 will phase change from green light to red light, and then the green light 371 will be switched on. In examples of the present disclosure, because an emergency vehicle 391 of FIG. 3 is present, the green light 371 of the traffic light 342 facing the emergency vehicle is flashing at a predetermined frequency so as to warn other vehicles to yield to the emergency vehicle 391. In one example, the predetermined frequency is 2 Hertz when the emergency vehicle 391 is not blocked by other vehicles. In another example, the predetermined frequency is 5 Hertz when the emergency vehicle 391 is blocked by another vehicle. Block 410 may be followed by block 418.

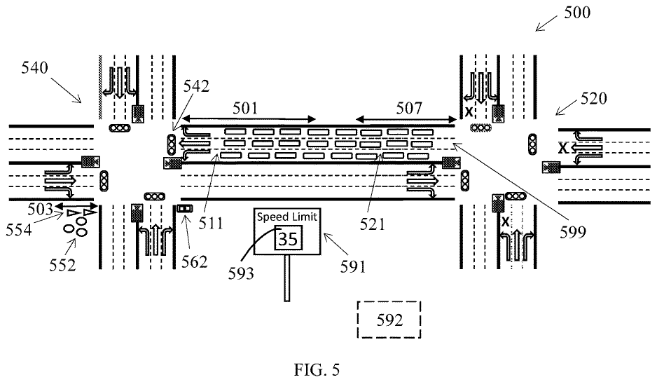

In block 412, from the image data of each incoming direction, a respective number of a plurality of vehicles 511 of FIG. 5 in each incoming direction of the three or more branches within a predetermined distance 501 of FIG. 5 and a respective speed of each of the plurality of vehicles 511 are determined. FIG. 5 shows two intersections 500 in examples of the present disclosure. The two intersections 500 comprises a first intersection 520 and a second intersection 540.

In examples of the present disclosure, a speed limit is determined using a weather condition. The determined speed limit is then displayed on a speed limit sign 591. In one example, the speed limit sign 591 comprises an electronic display 593. Though the electronic display 593 of FIG. 5 shows 35 miles per hour, the speed limit may vary. In one example, there is a default speed limit [for example, 35 miles per hour (MPH)]. The speed limit is a predetermined value [for example, 10 miles per hour] lower than a default speed limit when the weather condition is raining. The speed limit is a predetermined value [for example, 20 miles per hour] lower than a default speed limit when the weather condition is foggy.

In one example, the weather condition is determined from the image data. In another example, the weather condition is from a weather station 592 (shown in dashed lines).

The respective speed of each of the plurality of vehicles 511 of FIG. 5 is compared with the speed limit. In response to a determination that a speed of a speeding vehicle is above the speed limit, flashing a yellow light, a red light, or the yellow light and the red light of a selected traffic light 542 of FIG. 5 facing the speeding vehicle. In one example, the flashing frequency is 1 Hertz when the speed of the speeding vehicle is less than 5 MPH above the predetermined speed limit. In another example, the flashing frequency is 2 Hertz when the speed of the speeding vehicle is less than 10 MPH above the predetermined speed limit. In still another example, the flashing frequency is 3 Hertz when the speed of the speeding vehicle is less than 15 MPH above the predetermined speed limit. In yet still another example, the flashing frequency is 4 Hertz when the speed of the speeding vehicle is more than 15 MPH above the predetermined speed limit.

From the image data of each outgoing direction, a respective number of a plurality of outgoing vehicles 521 of FIG. 5 in each outgoing direction of the three or more branches within another predetermined distance 507 of FIG. 5 and a respective speed of each of the plurality of outgoing vehicles 521 are determined. Determine if a traffic jam condition is present when the respective number of the plurality of outgoing vehicles 521 is larger than a predetermined number and the respective speed of each of the plurality of outgoing vehicles 521 is smaller than a predetermined speed threshold. In one example, the predetermined speed threshold is 0 MPH. In another example, the predetermined speed threshold is 5 MPH. In still another example, the predetermined speed threshold is 10 MPH. In yet still another example, the predetermined speed threshold is 15 MPH. In response to a determination that the traffic jam condition is present for an outgoing direction 599 of FIG. 5, reducing on-duration of a green light of each traffic light allowing vehicles entering the outgoing direction 599 (see the three “X” mark in FIG. 5). Sending information of the traffic jam condition to a cloud server 208 of FIG. 2 so that a map with road conditions is updated and users of the map are notified. Block 412 may be followed by block 418.

In block 414, from the image data of each incoming direction, it is determined that pedestrians 552 of FIG. 5 or bicycles 554 of FIG. 5 are present at the intersection. A respective number of a plurality of pedestrians 552 and bicycles 554 in each incoming direction and each outgoing direction of the three or more branches within another predetermined distance 503 of FIG. 5 are determined. The predetermined distance 503 is shorter than the predetermined distance 501.

In examples of the present disclosure, the on-duration of green light will be extended by an additional time determined by an AI algorithm. This extension is applied when the AI algorithm, using captured images, detects the presence of an abnormally slow moving vehicle, e.g., having one or more flat tires, at the intersection. In examples of the present disclosure, the on-duration of a pedestrian crossing signal at a traffic light is extended by an additional time determined by an AI algorithm. This extension is applied when the AI algorithm, using captured images, detects the presence of a pedestrian at the intersection, using assistant equipment. The assistant equipment includes crutches and wheelchairs. In above examples, the traffic light condition remains unchanged until the slow moving object completes the crossing. Block 414 may be followed by block 416.

In block 416, priority of pedestrians'and bicycles'passing the streets are determined by AI and machine learning (ML) algorithm. Based at least on the respective number of the plurality of pedestrians 552 and bicycles 554, determine a plurality of cycles of switching-on timing and on-duration of each light of a plurality of pedestrian traffic lights 562 positioned at the intersection 540. Block 416 may be followed by block 418.

In block 418, traffic light orders and durations are determined by AI and ML algorithms. Block 418 may be followed by block 402 so as to form a loop 420.

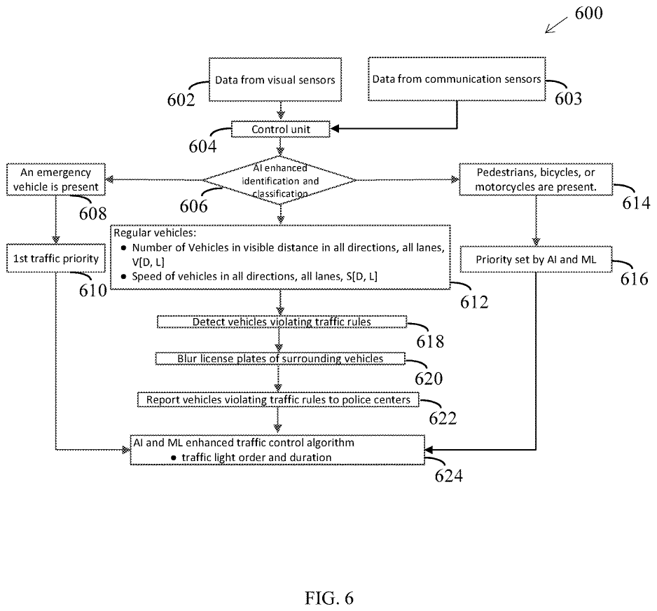

FIG. 6 is a flowchart of a method 600 for controlling traffic at an intersection in examples of the present disclosure. The intersection comprises three or more branches. For one example, an intersection 300 of FIG. 3 comprises four branches including a first branch 320, a second branch 340, a third branch 360, and a fourth branch 380. The method 600 may begin in block 602.

In block 602, data from visual sensors are collected. In one example, each of the plurality of camera units 202 of FIG. 2 comprises an infrared sensor 326 of FIG. 3. In another example, each of the plurality of camera units 202 comprises a microwave sensor 328 of FIG. 3. Block 602 may be followed by block 604.

In block 603, data from communication sensors are formed. In one example, the data are signals from an emergency vehicle 391 of FIG. 3. In another example, the data are signals from a public transit vehicle 389 of FIG. 3. Block 603 may be followed by block 604.

In block 604, the data from the visual sensors and the communication sensors are sent to the control unit 206 of FIG. 2. Block 604 may be followed by block 606.

In block 606, the data are processed by the control unit 206. Artificial intelligent (AI) enhanced identification and classification are determined. Block 606 may be followed by block 608, block 612, or block 614.

In block 608, from the data of each incoming direction, it is determined that an emergency vehicle 391 of FIG. 3 is present. Block 608 may be followed by block 610.

In block 610, the emergency vehicle 391 of FIG. 3 has the first (highest) priority. Because the emergency vehicle 391 is present, on-duration of a green light 371 of FIG. 3 of a traffic light 342 of FIG. 3 facing the emergency vehicle 391 is increased until the emergency vehicle 391 at least enters a center portion 301 of FIG. 3 of the intersection 300 of FIG. 3. Block 610 may be followed by block 624.

In block 612, from the data of each incoming direction, a respective number of a plurality of vehicles 511 of FIG. 5 in each incoming direction of the three or more branches within a predetermined distance 501 of FIG. 5 and a respective speed of each of the plurality of vehicles 511 are determined. FIG. 5 shows two intersections 500 in examples of the present disclosure. The two intersections 500 comprises a first intersection 520 and a second intersection 540.

In examples of the present disclosure, the on-duration of a green light or a yellow light of each light of the plurality of traffic lights 204 of FIG. 2 is adjusted using a weather condition. In one example, the on-duration of a green light increases by 10 seconds in a rainy day. In another example, the on-duration of a yellow light increases by 5 seconds in a rainy day. In still another example, the on-duration of a green light increases by 20 seconds in a foggy day. In yet still another example, the on-duration of a yellow light increases by 12 seconds in a foggy day.

In one example, the weather condition is determined from the image data. In another example, the weather condition is from a weather station 592 (shown in dashed lines).

After receiving a signal from an emergency vehicle 391 or a public transit vehicle 389, the control unit 206 causes a green light 371 of a traffic light facing the emergency vehicle 391 or the public transit vehicle 389 to flash at a predetermined frequency so as to warn other vehicles to yield to the emergency vehicle 391 or the public transit vehicle 389. The control unit 206 further causes the green light 371 of the traffic light facing the emergency vehicle 391 or the public transit vehicle 389 to increase on-duration until the emergency vehicle 391 or the public transit vehicle 389 enters a center portion 301 of the intersection 300. Block 612 may be followed by block 618.

A In block 614, from the data of each incoming direction, it is determined that pedestrians 552 of FIG. 5 or bicycles 554 of FIG. 5 are present at the intersection. In examples of the present disclosure, the on-duration of a pedestrian crossing signal at a traffic light is extended by an additional time determined by an AI algorithm. This extension is applied when the AI algorithm, using captured data, detects the presence of a pedestrian at the intersection, using assistant equipment. The assistant equipment includes crutches and wheelchairs. In above examples, the traffic light condition remains unchanged until the slow moving object completes the crossing. Block 614 may be followed by block 616.

In block 616, priority of pedestrians'and bicycles'passing the streets are determined by AI and machine learning (ML) algorithm. Based at least on the respective number of the plurality of pedestrians 552 and bicycles 554, determine a plurality of cycles of switching-on timing and on-duration of each light of a plurality of pedestrian traffic lights 562 positioned at the intersection 540. Block 616 may be followed by block 624.

In block 618, vehicles violating traffic rules are detected. In one example, a speed of a speeding vehicle 392 of FIG. 3 is above the speed limit. In another example, a violation vehicle 385 of FIG. 3 runs a red light.

The respective speed of each of the plurality of vehicles is compared with the speed limit. In response to a determination that a speed of a speeding vehicle 392 is above the speed limit, report a license plate number of the speeding vehicle 392 to a police center 399 of FIG. 3 (block 622).

After detecting a violation vehicle 385 running a red light, report a license plate number of the violation vehicle 385 to a police center 399 of FIG. 3 (block 622). Block 618 may be followed by block 620.

In block 620, a particular image data of the image data of each incoming direction is selected. The particular image data includes the speeding vehicle 392 and a plurality of surrounding vehicles (for example, vehicle 394 and vehicle 396). The particular image data is processed by blurring a plurality of license plates of the plurality of surrounding vehicles (for example, vehicle 394 and vehicle 396) forming a processed image data.

A particular image data of the image data of each incoming direction is selected. The particular image data includes the violation vehicle 385 and a plurality of surrounding vehicles (for example, vehicle 381 and vehicle 383). The particular image data is processed by blurring a plurality of license plates of the plurality of surrounding vehicles (for example, vehicle 381 and vehicle 383) forming a processed image data. Block 620 may be followed by block 622.

In block 622, the processed image data, showing the license plate number of the speeding vehicle 392, is sent to the police center. The processed image data, showing the license plate number of the violation vehicle 385, is sent to the police center. Block 622 may be followed by block 624.

In block 624, traffic light orders and durations are determined by AI and ML algorithms.

Those of ordinary skill in the art may recognize that modifications of the embodiments disclosed herein are possible. For example, a number of cameras positioned at an intersection may vary. Other modifications may occur to those of ordinary skill in this art, and all such modifications are deemed to fall within the purview of the present invention, as defined by the claims.

1. A method for controlling traffic at an intersection comprising three or more branches, the method comprising the steps of:
capturing by a plurality of camera units positioned at the intersection, image data of each incoming direction of the three or more branches;
sending the image data of each incoming direction to a control unit;
determining from the image data of each incoming direction, a respective number of a plurality of vehicles in each incoming direction of the three or more branches within a predetermined distance and a respective speed of each of the plurality of vehicles;
determining based at least in part on the respective number of the plurality of vehicles and the respective speed, a plurality of cycles of switching-on timing and on-duration of each light of a plurality of traffic lights positioned at the intersection; and
adjusting the on-duration of each light of the plurality of traffic lights using a weather condition.

2. The method of claim 1 further comprising the steps of:
receiving a signal from an emergency vehicle or a public transit vehicle;
in response to receiving the signal, the control unit causes
a green light of a traffic light facing the emergency vehicle or the public transit vehicle to flash at a predetermined frequency so as to warn other vehicles to yield to the emergency vehicle or the public transit vehicle; and
the green light of the traffic light facing the emergency vehicle or the public transit vehicle to increase on-duration until the emergency vehicle or the public transit vehicle enters a center portion of the intersection.

3. The method of claim 1, wherein each of the plurality of camera units comprises an infrared sensor or a microwave sensor.

4. The method of claim 1 further comprising the steps of:
comparing the respective speed of each of the plurality of vehicles with a speed limit; and
in response to a determination that a speed of a speeding vehicle is above the speed limit, reporting a license plate number of the speeding vehicle to a police center.

5. The method of claim 4, wherein the step of reporting the license plate number of the speeding vehicle to the police center comprising the sub-steps of:
selecting a particular image data of the image data of each incoming direction, the particular image data including the speeding vehicle and a plurality of surrounding vehicles;
processing the particular image data by blurring a plurality of license plates of the plurality of surrounding vehicles forming a processed image data; and
sending the processed image data, showing the license plate number of the speeding vehicle, to the police center.

6. The method of claim 1 further comprising the steps of:
detecting a violation vehicle running a red light; and
reporting a license plate number of the violation vehicle to a police center.

7. The method of claim 6, wherein the step of reporting the license plate number of the violation vehicle to the police center comprising the sub-steps of:
selecting a particular image data of the image data of each incoming direction, the particular image data including the violation vehicle and a plurality of surrounding vehicles;
processing the particular image data by blurring a plurality of license plates of the plurality of surrounding vehicles forming a processed image data; and
sending the processed image data, showing the license plate number of the violation vehicle, to the police center.

8. A system comprising
a plurality of camera units positioned at an intersection comprising three or more branches;
a plurality of traffic lights positioned at the intersection; and
a control unit;
wherein the system is configured to perform functions to:
capture by the plurality of camera units, image data of each incoming direction of the three or more branches;
send the image data of each incoming direction to the control unit;
determine from the image data of each incoming direction, a respective number of a plurality of vehicles in each incoming direction of the three or more branches within a predetermined distance and a respective speed of each of the plurality of vehicles;
determine based at least in part on the respective number of the plurality of vehicles and the respective speed, a plurality of cycles of switching-on timing and on-duration of each light of the plurality of traffic lights; and
adjust the on-duration of each light of the plurality of traffic lights using a weather condition.

9. The system of claim 8, wherein the system is further configured to perform functions to:
receive a signal from an emergency vehicle or a public transit vehicle;
in response to receiving the signal, the system causes
a green light of a traffic light facing the emergency vehicle or the public transit vehicle to flash at a predetermined frequency so as to warn other vehicles to yield to the emergency vehicle or the public transit vehicle; and
the green light of the traffic light facing the emergency vehicle or the public transit vehicle to increase on-duration until the emergency vehicle or the public transit vehicle enters a center portion of the intersection.

10. The system of claim 8, wherein each of the plurality of camera units comprises an infrared sensor or a microwave sensor.

11. The system of claim 8, wherein the system is further configured to perform functions to:
compare the respective speed of each of the plurality of vehicles with a speed limit; and
in response to a determination that a speed of a speeding vehicle is above the speed limit, report a license plate number of the speeding vehicle to a police center.

12. The system of claim 11, wherein to report the license plate number of the speeding vehicle to the police center comprises
to select a particular image data of the image data of each incoming direction, the particular image data including the speeding vehicle and a plurality of surrounding vehicles;
to process the particular image data by blurring a plurality of license plates of the plurality of surrounding vehicles forming a processed image data; and
to send the processed image data, showing the license plate number of the speeding vehicle, to the police center.

13. The system of claim 8, wherein the system is further configured to perform functions to:
detect a violation vehicle running a red light; and
report a license plate number of the violation vehicle to a police center.

14. The system of claim 13, wherein to report the license plate number of the violation vehicle to the police center comprises
to select a particular image data of the image data of each incoming direction, the particular image data including the violation vehicle and a plurality of surrounding vehicles;
to process the particular image data by blurring a plurality of license plates of the plurality of surrounding vehicles forming a processed image data; and
to send the processed image data, showing the license plate number of the violation vehicle, to the police center.

15. A non-transitory computer-readable storage medium storing instructions that, when executed by one or more processors of a control unit, cause the control unit to perform the steps of:
instructing a plurality of camera units positioned at an intersection comprising three or more branches to capture image data of each incoming direction of the three or more branches;
sending the image data of each incoming direction to the control unit;
determining from the image data of each incoming direction, a respective number of a plurality of vehicles in each incoming direction of the three or more branches within a predetermined distance and a respective speed of each of the plurality of vehicles;
determining based at least in part on the respective number of the plurality of vehicles and the respective speed, a plurality of cycles of switching-on timing and on-duration of each light of a plurality of traffic lights positioned at the intersection; and
adjusting the on-duration of each light of the plurality of traffic lights using a weather condition.

16. The non-transitory computer-readable storage medium of claim 15, wherein the instructions further cause the control unit to perform the steps of:
receiving a signal from an emergency vehicle or a public transit vehicle;
in response to receiving the signal, the control unit causes
a green light of a traffic light facing the emergency vehicle or the public transit vehicle to flash at a predetermined frequency so as to warn other vehicles to yield to the emergency vehicle or the public transit vehicle; and
the green light of the traffic light facing the emergency vehicle or the public transit vehicle to increase on-duration until the emergency vehicle or the public transit vehicle enters a center portion of the intersection.

17. The non-transitory computer-readable storage medium of claim 15, wherein the instructions further cause the control unit to perform the steps of:
comparing the respective speed of each of the plurality of vehicles with a speed limit; and
in response to a determination that a speed of a speeding vehicle is above the speed limit, reporting a license plate number of the speeding vehicle to a police center.

18. The non-transitory computer-readable storage medium of claim 17, wherein the step of reporting the license plate number of the speeding vehicle to the police center comprising the sub-steps of:
selecting a particular image data of the image data of each incoming direction, the particular image data including the speeding vehicle and a plurality of surrounding vehicles;
processing the particular image data by blurring a plurality of license plates of the plurality of surrounding vehicles forming a processed image data; and
sending the processed image data, showing the license plate number of the speeding vehicle, to the police center.

19. The non-transitory computer-readable storage medium of claim 15, wherein the instructions further cause the control unit to perform the steps of:
detect a violation vehicle running a red light; and
reporting a license plate number of the violation vehicle to a police center.

20. The non-transitory computer-readable storage medium of claim 19, the step of reporting the license plate number of the violation vehicle to the police center comprising the sub-steps of:
selecting a particular image data of the image data of each incoming direction, the particular image data including the violation vehicle and a plurality of surrounding vehicles;
processing the particular image data by blurring a plurality of license plates of the plurality of surrounding vehicles forming a processed image data;
sending the processed image data, showing the license plate number of the violation vehicle, to the police center.
